(19) United States
(12) Patent Application Publication
(10) Pub. No.: US 2009/0052681 A1
(43) Pub. Date: Feb. 26, 2009

(54) SYSTEM AND A METHOD OF PROCESSING AUDIO DATA, A PROGRAM ELEMENT, AND A COMPUTER-READABLE MEDIUM

(75) Inventors: Daniel Willem Schobben, Waalre (NL); Ronaldus Maria Aarts, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,150

(22) PCT Filed: Oct. 11, 2005
(86) PCT No.: PCT/IB2005/053333

§ 371 Date: Nov. 4, 2008

(30) Foreign Application Priority Data
Oct. 15, 2004 (EP) 04105092.3

(51) Int. Cl. G10K 15/08

(52) U.S. Cl. 381/63

(57) ABSTRACT

A system (100) for processing audio data comprises an extracting unit (101) adapted to extract a transient audio data part (103) from input audio data (102) and a reverberator unit (105) which is coupled to the extracting unit (101) so as to be provided with a transient audio data part (103), wherein the reverberator unit (104) is adapted to generate reverberation separately for the transient audio data part (103).

### FIELD OF THE INVENTION

The invention relates to a system of processing audio data.

The invention further relates to a method of processing audio data.

Moreover, the invention relates to a program element.

Furthermore, the invention relates to a computer-readable medium.

### BACKGROUND OF THE INVENTION

When sound is produced in an enclosed space, multiple reflections build up and together create a reverberation or reverb. This is particularly noticeable when the sound stops, but the reflections continue, decreasing in amplitude until they can no longer be heard.

Reverberation can be created artificially for both acoustical and recording purposes. Several different electronic mechanisms are used to create a reverberation effect. Mechanical solutions include a plate reverberator and a spring reverberator. A so-called DSP (“Digital Signal Processing”) reverberator uses electronics and signal processing algorithms to create a reverberation effect through the use of large numbers of long delays with quasi-random lengths, optionally combined with equalization, envelope sharing, and other processes. They may also use convolution and pre-recorded impulse response to simulate an existing real-life space.

According to the prior art, it is known that an exponentially decaying noise sequence can be used as a good artificial reverberation filter (see, for example, J. Martin, D. Van Maercke, J.-P. Vian, “Binaural simulation of concert halls: A new approach for the binaural reverberation process”, J. Acoust. Soc. Am., Volume 94, No. 6, Pages 3255-3264, 1993). Such a filter can be implemented as a long complex reverberation filter requiring many computations and a lot of memory.

Many reverberation generation algorithms are known in the prior art, for example from documents U.S. Pat. No. 4,105,864 or U.S. Pat. No. 5,917,917. More efficient time-varying reverberation filters are also known in the art, for example from U.S. Pat. No. 4,303,991 and from U.S. Pat. No. 5,553,150. These time-varying reverberation filters are inherently non-linear and only slightly more efficient, if they are to avoid introducing audible distortion. However, it may occur that such a time-varying reverberator distorts an audio signal.

U.S. Pat. No. 4,706,291 discloses a reverberation-imparting device having a level detection circuit for detecting the presence or absence of an input signal. Reverberation may be produced in a fixed way or in an adapted way in depenence on the detection result of the level detection circuit.

According to the document U.S. Pat. No. 4,706,291, however, the quality of the emitted acoustical signals may be insufficient, particularly in the case of a transient from a loud audio signal portion to a silent audio signal portion.

The computational load of algorithms is no longer an important issue in contemporary (mobile) computing equipment. Memory requirements are strict, however, and do not provide for good reverberation implementation algorithms.

### OBJECT AND SUMMARY OF THE INVENTION

It is an object of the invention to render it possible to reproduce an audio signal with a good subjective audio quality and with reasonable memory requirements, even in a scenario of a transient signal.

In order to achieve the object defined above, a system for processing audio data, a method of processing audio data and a program element, and a computer-readable medium with the features according to the independent claims are provided.

A system for processing audio data comprises an extracting unit adapted to extract a transient audio data part from input audio data, and a reverberator unit which is coupled to the extracting unit so as to be provided with the transient audio data part, wherein the reverberator unit is adapted to generate reverberation separately for the transient audio data part.

According to the method of processing audio data of the invention, a transient audio data part is extracted from input audio data, and reverberation is generated separately for the transient audio data part.

Furthermore, a program element is provided which is adapted, when executed by a processor, to carry out a method of processing audio data comprising the above-mentioned steps.

Moreover, a computer-readable medium is provided in which a computer program is stored which is adapted, when executed by a processor, to carry out a method of processing audio data comprising the above-mentioned method steps.

The processing of audio data of the invention may be realized by a computer program, that is to say by software, or by using one or more special electronic optimization circuits, that is to say in hardware, or in hybrid form, that is to say by means of software components and hardware components.

The characteristic features according to the invention have the particular advantage that a transient audio data part, that is to say a portion with a high degree of fluctuation as regards audio parameters such as loudness, extracted as a part of input audio data is treated separately as regards the reverberation to be added to the audio signal. Particularly, the way of how to produce reverberation and/or the amount of reverberation to be added may be different for the transient audio data part and for a stationary audio data part. This is advantageous, since a transient audio data part is more critical than a stationary audio data part, that is to say a portion with a low degree of fluctuation in its audio parameters, such as loudness, as regards the subjective feel of the quality of audio speech. The handling of the transient audio data part with a relatively sophisticated reverberation generation method strongly improves the subjective quality as perceived by a human listener. On the other hand, a stationary part of audio reverberation can be generated by a very simple reverberation method without any significant loss in the subjective quality felt by a human listener. Therefore, the memory requirements and the signal processing requirements of the system of the invention are reduced to a minimum; while at the same time a high perceived quality of sound reproduction is achieved with the additionally generated reverberation.

According to this description, the term “transient audio data part” particularly denotes a part of an audio signal in which a transition between a portion with relatively high amplitude and a portion with relatively low amplitude is present.

According to an embodiment of the invention, a transient may be assumed to be present when, in a predetermined time window, the signal amplitude decreases by more than a predetermined threshold value. In other words, the transition from a loud sound to a silent sound can be considered to be a transient. Such a transition, that is to say an offset of sound, will then be treated separately as regards its reverberation. For the subjective feeling of a human listener, an offset is more critical as to reverberation than an onset of sound, that is to say the transition from a silent sound to a loud sound. Thus, according to the described embodiment, only an offset, not an onset will be treated separately as regards its reverberation.

According to an alternative embodiment of the invention, a transient may be assumed when, in a predetermined time window, the signal amplitude decreases or increases by more than a predetermined threshold value. In other words, the transition from a loud sound to a silent sound, or vice versa, can be considered to be a transient according to this embodiment. The reverberation of an offset and of an onset of sound will then be treated separately.

The term “stationary audio data part” according to this description means a part of an audio signal in which the amplitude of the signal is relatively constant, that is to say changes are below a predetermined threshold value within a predetermined time window.

The present invention is based on the observation that reverberation is especially audible when transient sounds are played. In the case of a discussion in a large church at close distance, for example, reverberation is only experienced from the moment someone stops talking, and the echoes can be heard to die away slowly. When speaking continuously, the reverberation also has an effect, but this is mainly limited to the timbre of the speech. With timbre is meant that some frequencies are attenuated/amplified with respect to others. The transition from loud sounds to silence can be considered to be a transient.

Thus, the invention teaches to reverberate transient parts of a sound signal differently from reverberating stationary parts of a sound signal, particularly with a super-efficient time-varying reverberation filter, whereas stationary parts can be processed by a time-invariant reverberation filter which can be executed with little effort. To achieve this, transients are detected in an extracting unit and are separately processed in a reverberator unit so as to generate a separate reverberation contribution to be added to the transient audio data part. By contrast, the rest of the signal, that is to say the stationary part of the audio signal, may be treated separately to determine a reverberation contribution, which reverberation contribution is to be added to this stationary audio data part. Splitting-up of the reverberation generation scheme for transient audio data parts and stationary audio data parts generates reverberation in an efficient manner, while the memory requirements are as low as possible.

Thus a good reverberation for the transient part of the signal can be obtained when this transient part is extracted from the music signal and is fed into the system. After extraction of the transient part of the signal, only the stationary part is left. A good reverb can be generated for the latter with the use of a very small low-pass and all-pass filter combination. An algorithm, which may be used to classify transient and stationary parts of the signal, is based on a measurement of the energy in a certain window of the signal.

One aspect of the invention is related to a reverberation device comprising means for dividing an audio signal into transient and stationary parts, wherein reverberation for the transient parts and that for the stationary part are generated by different reverberation methods. The reverberation method to be used for the transient parts is preferably time-variant, thus providing a very precise and accurate estimation of the reverberation contribution, whereas the reverberation method for the stationary part may be time-invariant and can be realized with little hardware effort and/or software effort.

Appropriate application fields of the reverberator system of the invention are all kinds of audio products. It is of immediate relevance for virtualizers, 3D headphones, portable audio devices, and the like.

The invention discloses a reverberation device for adding reverberation to an audio signal, comprising dividing means for dividing the audio signal into a transient part and a stationary part. Consequently, a large reverberation time is obtained with only little memory resources. There is a large technical and commercial potential for the disclosed method, mainly for portable infotainment and mobile terminals in which currently simple reverberation algorithms are used which are unable to provide a convincing out of head performance for headphone sound reproduction.

The invention teaches a method of creating efficient reverberations, with reduced memory, by dividing the audio into two parts, transient and stationary, based on a signal level criterion or criteria. Then, separate reverberation generation algorithms may be used, namely time-invariant and time-variant reverberation generation algorithms, for said stationary and transient parts, respectively, so as to create long reverberation times by using only limited memory resources.

A super-efficient reverberation method and apparatus is provided thereby.

Further preferred embodiments of the invention will now be described below with reference to the dependent claims. These embodiments may be used for the method, for the program element, and for the computer-readable medium.

In the system, the extracting unit may be adapted to divide input audio data into a transient audio data part and a stationary audio data part. This division assumes that an audio signal contains only these two contributions. This, however, is a very good approximation in many cases and allows a numerically modelling of the system.

The reverberator unit may be coupled to the extracting unit such that it is provided with a stationary audio data part, wherein the reverberator unit may be adapted to generate reverberation separately for the stationary audio part. The two separated parts of the signal, namely transient and stationary parts, can be treated separately as regards their reverberation. In a stationary part, where reverberation is not very critical for the human ear, a very simple reverberation method may be used, whereas a proper selection of an amount of reverberation added is more critical to the subjective feeling of a human ear in a transient part. Particularly, a change from a very loud signal to a very silent signal is critical, even more than a change from a very silent signal to a loud signal. Thus, the latter two scenarios (loud to silent, silent to loud) in a transient audio data part are to be treated separately by the invention in that two different reverberation methods are applied to the latter two sub-aspects. Thus, a further refined reverberation generation is obtained.

The reverberator unit may be adapted to generate reverberation for the transient audio data part using a different reverberation determination method than in generating a reverberation for the stationary audio data part.

The reverberator unit may be adapted to generate reverberation for the transient audio data part separately in a time-variant manner. This provides very high-quality reverberation contribution estimation for the transient part, since it includes a sufficient number of degrees of freedom.

By contrast, the reverberator unit may be adapted to generate reverberation for the stationary audio part separately in a time-invariant manner, achieving a very efficient and low-effort reverberation method, thus keeping the memory requirements low.

The extracting unit may be adapted to extract the transient audio data part from a provided audio data on the basis of a level analysis of an input audio data. Thus, the amplitude of the acoustic signal and its variation in time is used for deciding whether or not a part of a considered audio signal has a transient audio data contribution.

The extracting unit may also be adapted to extract the transient audio data part from a provided audio data based on the basis of an analysis of an energy of the selected portion of input audio data. Thus, if a time slice of the audio signal has a first average amplitude and a subsequent time slice of the audio signal has a second average amplitude, the difference between the two average amplitudes can be taken as a proper basis for a decision as to whether the presence of a transient portion is assumed or not.

A subtracting unit may be provided in the system, which subtracting unit can be provided with a transient audio data part (extracted from input audio data) and which subtracting unit can be provided with input audio data, and which subtracting unit is adapted to determine a stationary audio part by subtracting the transient audio data part from the input audio data. This is a simple and very efficient method of separately providing the transient audio data part and the stationary audio data part, since only one detector is needed, namely for detecting the transient audio data part. The remaining part, that is to say the audio signal minus the determined transient part, is then estimated to be the stationary part, which requires only a single subtraction operation.

Furthermore, an adding unit may be provided which may be adapted to generate output audio data comprising a reverberation-containing transient audio data part and a reverberation-containing stationary audio data part. The adding unit may add the transient audio data part, the generated reverberation for the transient audio data part, the stationary audio data part, and the generated reverberation for the stationary audio data part so as to generate output audio data. However, the adding unit may also add reverberated transient audio data and reverberated stationary audio data. Such an adding unit serves to combine the individual contributions to the output signal.

The reverberator unit adapted to generate reverberation separately for the transient audio data part may generate reverberation by means of a feedback loop having a delay element and an attenuation element, wherein reverberation is generated by guiding of the transient audio data part through the feedback loop. Furthermore, the reverberator unit may comprise a summation unit adapted to sum the transient audio data part and the transient audio data part guided through the feedback loop. The reverberator unit may further comprise a multiplier adapted to multiply the sum of the transient audio data part and the transient audio data part guided from the feedback loop by a random signal. This latter embodiment (see FIG. 2) constitutes a very simple architecture for providing a super-efficient reverberator, which works perfectly if the input signal is non-zero for only one sample.

As an alternative to the previously described architecture, the reverberator unit adapted to generate reverberation separately for the transient audio data part may generate reverberation by means of a plurality of first multipliers arranged in parallel, each being adapted to generate its respective contribution to the reverberation to be generated. Furthermore, each of the multipliers may be adapted to multiply an associated one of delayed transient audio data parts by a factor defined by an associated power (square, cube, etc.) of an attenuation parameter and by an associated random signal. Moreover, the reverberator unit adapted to generate reverberation separately for the transient audio data part may generate reverberation by means of a plurality of delay elements arranged in series and adapted to generate the delayed transient audio data parts, a feedback loop including a second multiplier, and a summation unit adapted to sum the transient audio data part and the transient audio data part guided through the delay elements and the feedback loop. According to this preferred embodiment (see FIG. 3), architecture is provided for an efficient transient reverberator for generating a reverberation contribution for a transient audio data part, which architecture has a structure so as to produce the reverberation in a time-dependent manner and with a high quality.

The system may comprise a headphone connected to the adding unit, the headphone being adapted to generate and emit acoustic waves based on the output audio signal. Alternatively, a loudspeaker may be used to produce the acoustic waves. If a headphone is used, the subjective quality felt by a human listener is more critical than in a situation in which a loudspeaker is implemented. Thus, the advantages of the invention of providing a high-quality audio signal with little memory are particularly prevalent in a headphone system.

The system of the invention may be realized as an integrated circuit, particularly as a semiconductor integrated circuit. In particular, the system may be realized as a monolithic IC that may be fabricated in silicon technology.

The system of the invention may be realized as a virtualizer, as a portable audio player, as an Internet radio device, as a DVD player (preferably with MP3 playback facility), and so on.

The aspects defined above and further aspects of the invention will become apparent from the examples of embodiments to be described below and are explained with reference to these examples.

### BRIEF DESCRIPTION OF THE DRAWINGS

The invention will be described in more detail hereinafter with reference to examples of embodiments without being limited thereto.

FIG. 1 shows a system for processing audio data according to a preferred embodiment of the invention.

FIG. 2 shows a reverberator unit as an embodiment of an efficient transient reverberator to be implemented in the system for processing audio data shown in FIG. 1.

FIG. 3 shows a reverberator unit as another embodiment of an efficient transient reverberator to be implemented in the system for processing audio data shown in FIG. 1.

### DESCRIPTION OF EMBODIMENTS

The illustration in the drawing is schematic. Similar or identical elements have been provided with the same reference signs in the various drawings.

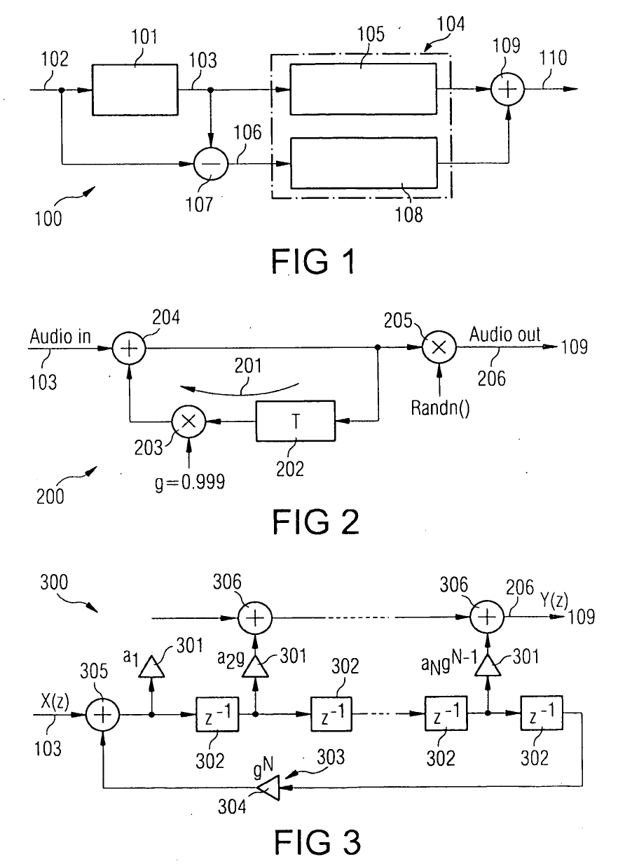

An audio processing system 100 according to a preferred embodiment of the invention will be described below with reference to FIG. 1.

The audio processing system 100 comprises a transient detector 101 adapted to extract a transient audio data part 103 from input audio data 102. A reverberator unit 104 is further provided, having a transient reverberator 105 that is coupled to the transient detector 101 so as to receive the transient audio data part 103. The transient reverberator 104 is adapted to generate reverberation separately for the transient audio data part 103. Moreover, the transient detector 101 together with a subtracting unit 107 is adapted to divide the input audio data 102 into the transient audio data part 103 and a stationary audio data part 106. Furthermore, a stationary reverberator 108 of the reverberator unit 105 is coupled to the transient detector 101 so as to be provided with the stationary audio data part 106. The stationary reverberator 108 of the reverberator unit 104 is adapted to generate reverberation separately for the stationary audio data part 106.

The reverberator unit 104 is thus adapted to generate reverberation for the transient audio data part 103 by a reverberation determination method (implemented in the transient reverberator 105) different from that used for generating reverberation for the stationary audio data part 106 (having a reverberation determination method implemented in the stationary reverberator 108). As will be described below with reference to FIG. 2 and FIG. 3, the transient reverberator 105 is adapted to generate separate reverberation for the transient audio data part 103 in a time-variant manner. In contrast to this, the stationary reverberator 108 is adapted to generate separate reverberation for the stationary audio data part 106 in a time-constant manner. Examples for the structure of the unit 108 are known from the prior art; examples for the structure of the unit 105 are shown, for example, in FIGS. 2 and 3.

The transient detector 101 is adapted to extract the transient audio data part 103 from the provided audio data input signal 102 on the basis of a level analysis of the input audio data 102. Thus, the energy of a selected portion of the input audio data 102 is analyzed by the transient detector 101 to determine whether a particular portion of an audio signal should be classified as a transient audio signal or as a stationary audio signal.

The subtracting unit 107 is provided with the transient audio data part 103 at a first input and is provided with the input audio data 102 at a second input. The subtracting unit 107 determines the stationary audio data part 106 by subtracting the transient audio data part 103 from the input audio data part 102 and provides the stationary audio data part 106 at an output of the subtracting unit 107, which output of the subtracting unit 107 is coupled to an input of the stationary reverberator 108.

Furthermore, an adding unit 109 is provided to be coupled to an output of the transient reverberator 105 and to an output of the stationary reverberator 108 and is adapted to add output signal contributions provided by units 105, 108 to generate an output audio data 110, which is provided as an output of the audio processing system 100.

As indicated in FIG. 1, this output audio data 110 is directed to a left output of a headphone (not shown). Alternatively, a loudspeaker may be provided instead of headphones. In the case of headphones, the original audio may be processed in parallel with a filter that models the direct path to the ears and the early reflections. The reverberated sound is delayed and added to this. A similar separate structure as shown for the audio processing system 100 may be provided to generate a right output of a headphone having separate audio processing systems for a left ear and for a right ear of a human listener (or for a left loudspeaker and a right loudspeaker). However, for a very compact configuration, the audio processing system 100 may produce an audio signal 110 that is guided to both the left and the right headphone. Alternatively, the transient detector 101 may base its decisions on the left (L) and right (R) signals, and the delay line in the transient reverberator 105 may be filled with left (L) and right (R), too. Different reverb for left and right is then obtained by using-different coefficients a₁ to a_{N} (see FIG. 3 and corresponding description) for left (L) and right (R).

FIG. 1 shows the full block diagram of the entire system of the invention. The transient reverberator 105 may be implemented as shown in FIG. 2 or, even more preferably, as shown in FIG. 3, and the stationary reverberator 108 may be a very simple structure as known from the prior art (for example, may be formed from all-pass filter structures).

FIG. 1 illustrates the hybrid approach of the invention: Transients are detected in the input signal 102 by the transient detector 101 and are transmitted to the super-efficient time-varying reverberator 105. The difference between the original signal and the transients is considered to be the stationary part and is processed separately by the efficient time-invariant reverberator 108.

A transient reverberator 200 according to a first embodiment of the invention will be described below with reference to FIG. 2. The transient reverberator 200 may be used to implement the transient reverberator 105 shown in FIG. 1.

The transient reverberator 200 is adapted to generate reverberation separately for the transient audio data part 103 by using a feedback loop 201 having a delay element 202 and an attenuation element 203. Guiding the transient audio data part 103 through the feedback loop 201 generates said reverberation. The transient reverberator 200 further comprises a summation unit 204 adapted to sum the transient audio data part 103 and the transient audio data part 103 after being guided through the feedback loop 201. Reverberation is added to the transient audio data part 103 in the summation unit 204. As can be seen from FIG. 2, the attenuation factor of the attenuation element 203 is 0.999 in the present embodiment. However, the attenuation may have a different value slightly smaller than one, for instance 0.99 or 0.9999. The attenuation factor determines the reverberation time of the filter.

The transient reverberator 200 further comprises a multiplier 205 adapted to multiply the sum of the transient audio data part 103 and the transient audio data part 103 guided through the feedback loop 201 by a random signal denoted Randn( ). The output 206 of the transient reverberator 200 may be coupled to the adding unit 109 shown in FIG. 1.

FIG. 2 accordingly shows an exemplary embodiment of how a transient audio data part 103 can be processed such that a reverberation contribution is added to this signal, using only one delay element 202 while achieving any desired reverberation length. However, the generated reverberation need not necessarily be added to the original signal. Alternatively, the original signal may be reverberated. FIG. 2 shows a super-efficient reverberator that works perfectly if the input signal is non-zero for only one sample.

The method disclosed reverberates transients and stationary parts of a sound signal in different ways, that is to say the former with a super-efficient time-varying reverberation filter such as the one shown in FIG. 1 or 3. The more stationary components are less important and are filtered by means of simple fixed filters, such as the efficient stationary reverberator 108. This hybrid approach realizes a system with a large reverberation time using only little memory resources.

The embodiment shown in FIG. 2 is particularly suitable for a pulsed signal. The attenuation number of the attenuation element 203 (a multiplier) is a number that is close to and below one (1) so as to achieve a long response. The signal Randn( ) fed into the multiplier 205 is a random sequence, that is to say a white-noise signal.

A transient reverberator 300 according to another embodiment of the invention will be described below with reference to FIG. 3. The transient reverberator 300 is preferably implemented as the transient reverberator 105 of FIG. 1.

The transient reverberator 300 is adapted to generate reverberation separately for the transient audio data part 103 by using a plurality of first multipliers 301 arranged in parallel. Each of the multipliers 301 is adapted to generate a contribution to the reverberation to be generated. Each of the multipliers 301 (which may also be denoted sub-filters of the filter 300) is adapted to multiply an associated one of delayed transient audio data parts by a factor defined by the product aₙgⁿ⁻¹ of an associated power n of an attenuation parameter g, so gⁿ⁻¹, and an associated random signal aₙ, wherein n=1, 2, . . . , N.

The transient reverberator 300 adapted to generate reverberation separately for the transient audio data part 103 by using a plurality of serially arranged delay elements 302 adapted to generate the delayed transient audio data parts, a feedback loop 303 including a second multiplier 304, and a summation unit 305 adapted to sum the transient audio data part 103 and the transient audio data part 103 guided through the delay elements 302 and through the feedback loop 303.

Second summation units 306 are provided to sum up the output signals of the first multipliers 301 in the manner shown in FIG. 3 so as to generate a reverberation-containing transient audio data signal at an output 206. This signal can be supplied to the adding unit 109 shown in FIG. 1.

Thus, FIG. 3 shows an implementation that is preferably used as the transient reverberator 105 in FIG. 1. The coefficients an are chosen as an exponentially decaying white noise sequence, so that it will work as a good reverberator (“Moore's Ideal Reverberator”). FIG. 3 may be considered to be a generalization of FIG. 1, and it works perfectly for input signals that are non-zero for up to N samples. The number of memory elements used is N here. So it is possible to make a filter with only N delay elements 302 that operate as an infinite-length filter having a decaying white-noise sequence. This can be implemented by changing the filter coefficients aₙ one at time from a₁ to a_{N} and again back to a₁. Here, the attenuation in the feedback loop is g^{N} for a smooth exponential decay of the reverb tail.

Any reverberation time can be obtained through the choice of the value g. In practice, using N=400 gives excellent results when realizing a reverberation time of 0.25 second when using a sampling frequency of 44.1 kHz.

It should be noted that the term “comprising” does not exclude other elements or steps and the article “a” or “an” does not exclude a plurality. Also, elements described in association with different embodiments may be combined.

It should also be noted that reference signs in the claims shall not be construed as limiting the scope of the claims.

1. A system (100) for processing audio data, comprising:
an extracting unit (101) adapted to extract a transient audio data part (103) from input audio data (102);
a reverberator unit (104) that is coupled to the extracting unit (101) and that is adapted to be provided with the transient audio data part (103), wherein the reverberator unit (104) is adapted to generate reverberation separately for the transient audio data part (103).

2. The system (100) according to claim 1, wherein the extracting unit (101) is adapted to divide input audio data (102) into a transient audio data part (103) and a stationary audio data part (106).

3. The system (100) according to claim 1, wherein the reverberator unit (104) is coupled to the extracting unit (101) so as to be provided with a stationary audio data part (106), and wherein the reverberator unit (104) is adapted to generate reverberation separately for the stationary audio data part (106).

4. The system (100) according to claim 3, wherein the reverberator unit (104) is adapted to generate reverberation for the transient audio data part (103) by a reverberation determination method different from that used for generating reverberation for the stationary audio data part (106).

5. The system (100) according to claim 1, wherein the reverberator unit (104) is adapted to generate reverberation separately for the transient audio data part (103) in a time-variant manner.

6. The system (100) according to claim 3, wherein the reverberator unit (104) is adapted to generate reverberation separately for the stationary audio data part (106) in a time-invariant manner.

7. The system (100) according to claim 1, wherein the extracting unit (101) is adapted to extract a transient audio data part (103) from input audio data (102) on the basis of a level analysis of input audio data (102).

8. The system (100) according to claim 1, wherein the extracting unit (101) is adapted to extract a transient audio data part (103) from a provided audio data on the basis of an analysis of an energy level of a selected portion of input audio data (102).

9. The system (100) according to claim 1, further comprising a subtracting unit (107) which is provided with a transient audio data part (103) and which is provided with input audio data (102), wherein the subtracting unit (107) is adapted to determine a stationary audio data part (106) by subtracting the transient audio data part (103) from the input audio data (102).

10. The system (100) according to claim 3, comprising an adding unit (109) adapted to generate output audio data (110) comprising a reverberation-containing transient audio data part and a reverberation-containing stationary audio data part (106).

11. The system (100) according to claim 1, wherein the reverberator unit (104) adapted to generate reverberation separately for the transient audio data part (103) generates reverberation by means of a feedback loop (201) having a delay element (202) and an attenuation element (203), wherein reverberation is generated by guiding the transient audio data part (103) through the feedback loop (201).

12. The system (100) according to claim 11, wherein the reverberator unit (104) further comprises a summation unit (204) adapted to sum the transient audio data part (103) and the transient audio data part (103) guided through the feedback loop (201).

13. The system (100) according to claim 12, wherein the reverberator unit (104) further comprises a multiplier (205) adapted to multiply the sum of the transient audio data part (103) and the transient audio data part (103) guided through the feedback loop (201) by a random signal.

14. The system (100) according to claim 1, wherein the reverberator unit (104) adapted to generate reverberation separately for the transient audio data part generates reverberation by means of a plurality of first multipliers (301) arranged in parallel, each multiplier being adapted to generate a contribution to the reverberation to be generated.

15. The system (100) according to claim 14, each of the multipliers (301) being adapted to multiply an associated one of delayed transient audio data parts (103) by a factor defined by an associated power of an attenuation parameter and by an associated random signal.

16. The system (100) according to claim 15, wherein the reverberator unit (104) adapted to sgenerate reverberation separately for the transient audio data part (103) generates reverberation by means of a plurality of serially arranged delay elements (302) adapted to generate the delayed transient audio data parts, a feedback loop (303) including a second multiplier (304), and a summation unit (305) adapted to sum the transient audio data part (103) and the transient audio data part (103) guided through the delay elements (302) and the feedback loop (303).

17. The system (100) according to claim 10, comprising a headphone connected to the adding unit (109), the headphone being adapted to generate and emit acoustic waves based on the output audio data.

18. The system (100) according to claim 1, realized as an integrated circuit.

19. The system (100) according to claim 1, realized as a virtualizer or as a portable audio player or as a DVD player or as an MP3 player or as an internet radio device.

20. A method of processing audio data, the method comprising the steps of:
extracting a transient audio data part (103) from input audio data (102); and
separately generating reverberation for the transient audio data part (103).

21. A program element which is adapted to carry out, when executed on a processor, a method of processing audio data comprising the steps of:
extracting a transient audio data part (103) from input audio data (102); and
separately generating reverberation for the transient audio data part (103).

22. A computer-readable medium, which is adapted to carry out, when executed on a processor, a method of processing audio data comprising the steps of:
extracting a transient audio data part (103) from input audio data (102); and
separately generating reverberation for the transient audio data part (103).
